(19) United States
(12) Patent Application Publication
(10) Pub. No.: US 2025/0383476 A1
(43) Pub. Date: Dec. 18, 2025

(54) STACKED BODY FOR DISPLAY DEVICE AND DISPLAY DEVICE

(71) Applicant: DAI NIPPON PRINTING CO., LTD., Tokyo (JP)

(72) Inventors: Jun SATO, Tokyo (JP); Kenichi ONODERA, Tokyo (JP); Kazuya HONDA, Tokyo (JP); Saori KAWAGUCHI, Tokyo (JP); Kana HORII, Tokyo (JP)

(21) Appl. No.: 18/695,253

(22) PCT Filed: Sep. 30, 2022
(86) PCT No.: PCT/JP2022/036738

§ 371 Date: Jan. 3, 2025

(30) Foreign Application Priority Data
Sep. 30, 2021 (JP) 2021-162220

(51) Int. Cl. G02B 1/115

(52) U.S. Cl. CPC G02B 1/115

(57) ABSTRACT

The present disclosure provides a stacked body for a display device comprising a first inorganic compound layer, a second inorganic compound layer, a hard coating layer, and a substrate layer, in this order, wherein a difference ΔE1(E2−E1) between an erosion rate E1 at a first interface that is an interface between the first inorganic compound layer and the second inorganic compound layer; and an erosion rate E2 at a second interface that is an interface between the second inorganic compound layer and the hard coating layer, is in a range of −1.0×10⁻² μm/g or more and 1.0×10⁻¹ μm/g or less.

### TECHNICAL FIELD

The present disclosure relates to a stacked body for a display device and a display device.

### BACKGROUND ART

For example, a stacked body provided with a functional layer having various properties such as a hard coating property, an abrasion resistance, antireflection property, an antiglare property, an antistatic property, and an antifouling property, is placed on the surface of a display device.

Patent Document 1 discloses an optical film used for a display device, the optical film including acrylic resin film, wherein an abrasion rate (μm/g) by a micro slurry erosion (MSE) test is in a range of 0.7 or more and 1.4 or less; and number of times of folding endurance measured according to JIS P8115 is 300 times or more.

Recently, flexible display devices such as foldable displays, rollable displays, and bendable displays have been attracting attention, and the development of the stacked body placed on the surface of the flexible display devices has been actively promoted.

The flexible display devices are required to prevent display defects even if they are bent repeatedly, and stacked bodies placed on the surface of the flexible display devices are required to have bending resistance that does not cause peeling or cracking when they are bent repeatedly. In particular, in the stacked body including a functional layer having an antireflection performance, display defects caused by bending may be conspicuous, so better bending resistance is required.

### CITATION LIST

### Patent Document

Patent Document 1: Japanese Patent Application Laid-Open (JP-A) No. 2016-71274

### SUMMARY OF DISCLOSURE

### Technical Problem

The present disclosure has been made in view of the above circumstances, and a main object of the present disclosure is to provide a stacked body for a display device and a display device with excellent bending resistance.

### Solution to Problem

One embodiment of the present disclosure provides a stacked body for a display device comprising a first inorganic compound layer, a second inorganic compound layer, a hard coating layer, and a substrate layer, in this order, wherein a difference ΔE1(E2−E1) between an erosion rate E1 at a first interface that is an interface between the first inorganic compound layer and the second inorganic compound layer; and an erosion rate E2 at a second interface that is an interface between the second inorganic compound layer and the hard coating layer, is in a range of −1.0×10⁻² μm/g or more and 1.0×10⁻¹ μm/g or less.

In the stacked body for a display device in the present disclosure, a difference ΔE2(E3−E1) between an erosion rate E3 of the first inorganic compound layer; and the erosion rate E1 at the first interface, is preferably in a range of 0.0 μm/g or more and less than 2.0×10⁻² μm/g.

Also, in the present disclosure, a refractive index of the first inorganic compound layer is preferably less than a refractive index of the second inorganic compound layer.

Further, a fluorine-containing layer is preferably included on a surface of the first inorganic compound layer that is opposite side to the second inorganic compound layer.

In the stacked body for a display device in the present disclosure, a first inorganic compound included in the first inorganic compound layer is preferably silicon oxide.

Also, in the stacked body for a display device in the present disclosure, a thickness of the first inorganic compound layer is preferably 30 nm or more and 200 nm or less.

In the stacked body for a display device in the present disclosure, a total thickness of the first inorganic compound layer and the second inorganic compound layer is preferably 500 nm or less.

Also, in the stacked body for a display device in the present disclosure, a second inorganic compound included in the second inorganic compound layer is preferably any one of aluminum oxide, zirconium oxide, and niobium oxide.

Further, in the stacked body for a display device in the present disclosure, a thickness of the second inorganic compound layer is preferably 20 nm or more and 300 nm or less.

In the stacked body for a display device in the present disclosure, a luminous reflectance of regular reflection light, when light is entered to a first inorganic compound layer side surface with incident angle of 5°, may be 2.0% or less.

Also, in the stacked body for a display device in the present disclosure, an adhesive layer for adhesion may be included on a surface of the substrate layer that is opposite side to a hard coating layer side surface.

Another embodiment of the present disclosure provides a display device comprising: a display panel, and the stacked body for a display device described above placed on an observer side of the display panel.

### Advantageous Effects of Disclosure

The present disclosure has an effect that a stacked body for a display device and a display device with excellent bending resistance may be provided.

### BRIEF DESCRIPTION OF DRAWINGS

FIG. 1 is a schematic cross-sectional view illustrating an example of a stacked body for a display device of the present disclosure.

FIG. 2 is a schematic cross-sectional view illustrating another example of the stacked body for a display device of the present disclosure.

FIG. 3 is a schematic cross-sectional view illustrating another example of the stacked body for a display device of the present disclosure.

FIG. 4 is a schematic cross-sectional view illustrating an example of a display device of the present disclosure.

FIG. 5 are views explaining a dynamic bending test method.

### DESCRIPTION OF EMBODIMENTS

Embodiments in the present disclosure are hereinafter explained with reference to, for example, drawings. However, the present disclosure is enforceable in a variety of different forms, and thus should not be taken as is limited to the contents described in the embodiments exemplified as below. Also, the drawings may show the features of the present disclosure such as width, thickness, and shape of each part schematically comparing to the actual form in order to explain the present disclosure more clearly in some cases; however, it is merely an example, and thus does not limit the interpretation of the present disclosure. Also, in the present descriptions and each drawing, for the factor same as that described in the figure already explained, the same reference sign is indicated and the detailed explanation thereof may be omitted.

In the present descriptions, in expressing an aspect wherein some member is placed on the other member, when described as merely “on” or “below”, unless otherwise stated, it includes both of the following cases: a case wherein some member is placed directly on or directly below the other member so as to be in contact with the other member, and a case wherein some member is placed on the upper side of the lower side of the other member via yet another member. Also, in the present descriptions, on the occasion of expressing an aspect wherein some member is placed on the surface of the other member, when described as merely “on the surface side” or “on the surface”, unless otherwise stated, it includes both of the following cases: a case wherein some member is placed directly on or directly below the other member so as to be in contact with the other member, and a case wherein some member is placed on the upper side or the lower side of the other member via yet another member.

The inventors of the present disclosure have found out that, in a stacked body for a display device comprising a first inorganic compound layer, a second inorganic compound layer, a hard coating layer, and a substrate layer, in this order, a peeling may occur and the bending resistance may be inferior between the first inorganic compound layer and the second inorganic compound layer, or between the second inorganic compound layer and the hard coating layer.

As the result of intensive studies about the bending resistance of the stacked body for a display device, the inventors of the present disclosure have found out that the close adhesiveness between the layers of the stacked body including an inorganic compound layer and hard coating layer correlates with the erosion rate at the interface thereof. Specifically, they have found out that, when the close adhesiveness at the interface is low, the erosion rate varies according to the depth location of the interface, and as the result, the erosion rate increases. In other words, they have found out tendencies that the higher the interface erosion rate, the lower the interface close adhesiveness, and the lower the interface erosion rate, the higher the interface close adhesiveness.

Further, the inventors of the present disclosure have found out that the bending resistance of the stacked body is improved when the difference ΔE1(E2−E1) between an erosion rate E1 at the interface between the first inorganic compound layer and the second inorganic compound layer; and an erosion rate E2 at the interface between the second inorganic compound layer and the hard coating layer, is in a predetermined range, and thereby achieved the present invention. The stacked body for a display device in the present disclosure is hereinafter described in detail.

### A. Stacked Body for Display Device

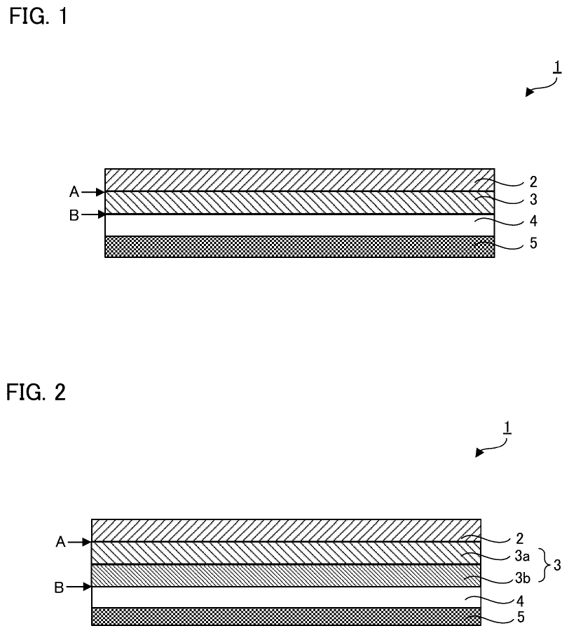

FIG. 1 is a schematic cross-sectional view illustrating an example of a stacked body for a display device in the present disclosure. As shown in FIG. 1, a stacked body for a display device 1 in the present disclosure comprises a first inorganic compound layer 2, a second inorganic compound layer 3, a hard coating layer 4 and a substrate layer 5, in this order.

The present disclosure is characterized in that the difference ΔE1(E2−E1) between an erosion rate E1 at a first interface A that is an interface between the first inorganic compound layer 2 and the second inorganic compound layer 3; and an erosion rate E2 at a second interface B that is an interface between the second inorganic compound layer 3 and the hard coating layer 4, is in a range of −1.0×10⁻² μm/g or more and 1.0×10⁻¹ μm/g or less.

FIG. 1 illustrates a case where the second inorganic compound layer 3 is a single layer film. Meanwhile, when the second inorganic compound layer is a multilayer film including a plurality of inorganic compound films, the first interface is an interface between the first inorganic compound layer and an inorganic compound film of the second inorganic compound layer on the most first inorganic compound layer side. Also, the second interface is an interface between the hard coating layer and an inorganic compound film of the second inorganic compound layer on the most hard coating layer side. In other words, as shown in FIG. 2, when the second inorganic compound layer 3 is a multilayer film including, for example, an upper layer film 3a and a lower layer film 3b, the first interface A is an interface between the first inorganic compound layer 2 and the upper layer film 3a in the second inorganic compound layer 3; and the second interface B is an interface between the hard coating layer 4 and the lower layer film 3b in the second inorganic compound layer 3.

In the stacked body for a display device in the present disclosure, occurrence of a peeling at the bent portion of the first interface may be suppressed by ΔE1(E2−E1) being −1.0×10⁻² μm/g or more. When ΔE1(E2−E1) is less than −1.0×10⁻² μm/g, the second interface is too strongly adhered, compared to the first interface, a stress is concentrated at the first interface when the stacked body is bent, and a peeling occurs at the bent portion of the first interface.

Meanwhile, occurrence of a peeling at the bent portion of the second interface B may be suppressed by ΔE1(E2−E1) being 1.0×10⁻¹ μm/g or less.

When ΔE1(E2−E1) is a value more than 1.0×10⁻¹ μm/g, the close adhesiveness at the second interface is not sufficient, a stress is concentrated at the second interface when the stacked body is bent, and a peeling occurs at the bent portion of the second interface.

Incidentally, when the second inorganic compound layer is a multilayer film, the interface between adjacent inorganic compound films in the second inorganic compound layer does not affect the bending resistance of the stacked body. This is because the bending resistance of the stacked body is greatly influenced by the close adhesiveness of the first interface and the second interface, and since the stress is concentrated at the first interface or the second interface rather than in the second inorganic compound layer, a peeling occurs at the first interface or the second interface before a peeling occurs in the second inorganic compound layer.

Therefore, a stacked body for a display device with excellent bending resistance may be provided. Each constitution of the stacked body for a display device in the present disclosure is hereinafter described in detail.

### 1. Erosion Rate

### (1) ΔE1(E2−E1)

In the stacked body for a display device in the present disclosure, the difference ΔE1(E2−E1) between an erosion rate E1 at a first interface A that is an interface between the first inorganic compound layer and the second inorganic compound layer; and an erosion rate E2 at a second interface B that is an interface between the second inorganic compound layer and the hard coating layer, is in a range of −1.0×10⁻² μm/g or more and 1.0×10⁻¹ μm/g or less. Preferably, it is in a range of −8.0×10⁻³ μm/g or more and 8.0×10⁻² μm/g or less.

For example, ΔE1(E2-E1) is preferably in a range of −1.0×10⁻² μm/g or more and 0.0 μm/g or less, and more preferably in a range of −8.0×10⁻³ μm/g or more and 0.0 μm/g or less. The bending resistance may further be improved.

Meanwhile, it is also possible to be in a range of 0.0 μm/g or more and 1.0×10⁻¹ μm/g or less, and may be in a range of in a range of 1.0×10⁻³ μm/g or more and 8.0×10⁻² μm/g or less.

The method for obtaining the value ΔE1(E2−E1) in the range described above, the erosion rate E1 at the first interface A and the erosion rate E2 at the second interface B are adjusted, and the erosion rate E1 at the first interface A and the erosion rate E2 at the second interface B may be adjusted, for example, by treating or not treating the surface of the second inorganic compound layer of the hard coating layer, or by adjusting the conditions of the surface treatment.

### (2) Method for Measuring Erosion Rate

In the present disclosure, the erosion rate is a value measured using a material surface precision tester (Micro Slurry Jet Erosion Tester, hereinafter MSE tester, device name: Nano MSE/model N-MSE-A from Palmeso Co., Ltd.).

Polygonal alumina powder (particles) having an average particle size D₅₀=0.7 μm is dispersed in water to prepare a slurry including 1% by mass of polygonal alumina powder with respect to the total mass of the slurry. A stacked body for a display device fixed on a jig is fixed to a device table so that a projection distance between the stacked body for a display device and a nozzle for spraying the slurry is set to 4 mm. The nozzle diameter is 1 mm×1 mm, and further, a mask with a 0.3 mm diameter hole is attached to the nozzle opening. The slurry including the polygonal alumina powder is sprayed from the nozzle so that the stacked body for a display device fixed to the table is eroded sequentially from the first inorganic compound layer side surface (erosion treatment).

The spray strength at this time is determined based on a standard projection force X, which is obtained by performing erosion of an existing PMMA substrate in advance under similar experimental conditions and obtaining an amount of surface displacement due to the erosion relative to the sprayed amount of the slurry (that is, a depth of cut due to spray of 1 g of slurry). In the present disclosure using the polygonal alumina powder, a projection force by which the existing PMMA substrate is eroded by 7.0 μm/g is defined as a standard projection force X, and the projection force is set to a projection force that is 1/100 of the standard projection force X (a projection force by which the existing PMMA substrate is eroded by 0.07 μm/g).

After the eroded portion is washed with water, an erosion depth Z is measured (profile measurement). The erosion depth Z is measured using, for example, a stylus surface profilometer (model No. PU-EU1 from Kosaka Laboratory Ltd./stylus tip R=2 μm/load 100 μN/measurement magnification 20,000/measurement length 4 mm/measurement speed 0.2 mm/sec).

Specifically, inclination correction is first performed by using reference areas “a” and “b” which are not worn on either end among the measurement length. Then, the difference in level from a regression line as a reference to a wear mark center portion “c” (average value of 50 μm width) is measured. Then, the erosion depth Z is obtained from the difference between the level difference data at 0 g projection and the level difference data at each projection amount.

The above erosion treatment and the profile measurement using the above profilometer are repeatedly performed for a predetermined number of times (N times), and the profile measurement data for N times is obtained. In the present disclosure, the erosion depth per unit projection particle amount, that is, an erosion rate E [μm/g] is calculated by using the projection particle amount X′ [g] and the erosion depth Z [μm] calculated from the above projection force, and an erosion progress graph and an erosion rate distribution graph (a graph of an erosion depth (vertical axis) and an erosion rate (horizontal axis)) are prepared.

In the present disclosure, the depth position of the first interface A in the stacking direction of the stacked body is determined in advance by a cross-sectional observation by, for example, a microscopic observation.

Using the graph obtained above, the average of the erosion rate of the erosion depth range corresponding to the range from the position 10 nm shallower than the depth position of the first interface A to the position 10 nm deeper than the depth position of the first interface A is defined as the erosion rate E1 at the first interface A. Similarly, the average of the erosion rate of the erosion depth range corresponding to the range from the position 10 nm shallower than the depth position of the second interface B to the position 10 nm deeper than the depth position of the second interface B is defined as the erosion rate E2 at the second interface B.

### (3) Erosion Rate of Each Interface

The erosion rate E1 of the first interface A is not particularly limited as long as it is a value within the range described above, and is, for example, 1.0×10⁻³ μm/g or more and 1.0×10⁻¹ μm/g or less, and may be 3.0×10⁻³ μm/g or more and 8.0×10⁻² μm/g or less.

The erosion rate E2 at the second interface B is not particularly limited as long as it is a value that ΔE1(E2−E1) is within the range described above, and is, for example, 1.0×10⁻³ μm/g or more and 1.0×10⁻¹ μm/g or less, and may be 3.0×10⁻³ μm/g or more and 8.0×10⁻² μm/g or less.

The erosion rate E1 at the first interface A may be adjusted by, prior to the formation of the first inorganic compound layer on the second inorganic compound layer, a surface treatment to the second inorganic compound layer that is an underlayer, and further by changing the surface treatment conditions.

Also, the erosion rate E2 at the second interface B may be adjusted by, prior to the formation of the second inorganic compound layer on the hard coating layer, a surface treatment to the hard coating layer that is an underlayer, and further by changing the surface treatment conditions.

Here, examples of a method for a surface treatment to be used may include a plasma treatment and a corona discharge treatment.

### 2. Layer Structure

### 2.1 First Inorganic Compound Layer

The first inorganic compound layer is a single inorganic compound layer located on the opposite side to and most far away from the substrate layer, among the inorganic compound layers included in the stacked body. The first inorganic compound layer is in direct contact with the second inorganic compound layer.

### (1) First Inorganic Compound

The first inorganic compound layer includes the first inorganic compound. The first inorganic compound is not particularly limited, and examples thereof may include inorganic oxides such as silicon oxides and gallium oxides.

Also, in the first inorganic compound layer, inorganic fluorides that is low refractive index material with lower refractive index than the second inorganic compound may be included as the first inorganic compound. The reason therefor is to obtain low reflectance. Examples of such inorganic fluoride may include aluminum fluoride, barium fluoride, cerium fluoride, gadolinium fluoride, lanthanum fluoride, lithium fluoride, magnesium fluoride, sodium fluoride, neodymium fluoride, ytterbium fluoride, and yttrium fluoride.

Among the above, in the present disclosure, silicon oxide is preferable in terms of refractive index and versatility.

Also, although the inorganic compound included in the first inorganic compound layer is preferably one type, and a plurality type of the inorganic compound may be included.

Incidentally, the average composition of the inorganic oxide is represented by, for example, MOx (in the formula, M represents a metallic element, and the ranges of the value “x” varies depending on respective metallic elements). For example, the average composition of the silicon oxide is represented by SiOx, and in the formula, “x” may satisfy 0<x≤2, preferably 1≤x≤2, more preferably SiO₂. In the present disclosure, the average composition of the inorganic oxides is not limited to the stoichiometrically optimal ones, as described above.

In the present disclosure, the first inorganic compound layer is preferably a vapor-deposition film. Particularly, it is preferably a silicon oxide (silica) vapor-deposition film.

The first inorganic compound layer may include not only the inorganic compounds described above, but also oxynitrides, oxycarbides, or oxycarbonitrides.

### (2) Erosion Rate E3

The difference between the erosion rate E3 of the first inorganic compound layer in the present disclosure and the erosion rate E1 at the first interface A is preferably in a predetermined range. Specifically, the difference ΔE2(E3−E1) between the erosion rate E3 of the first inorganic compound layer; and the erosion rate E1 at the first interface is preferably in a range of 0.0 μm/g or more and less than 2.0×10⁻² μm/g, and more preferably in a range of 3.0×10⁻³ μm/g or more and 1.9×10⁻² μm/g or less. When ΔE2(E3−E1) is too high, a peeling or a crack may occur in the first inorganic compound layer during the bending test.

The erosion rate E3 of the first inorganic compound layer is, for example, 3.0×10⁻³ μm/g or more and 5.0×10⁻² μm/q or less, and may be 5.0×10⁻³ μm/g or more and 3.0×10⁻² μm/g or less.

Incidentally, in the present disclosure, the average of the erosion rate of the erosion depth range corresponding to the range from the depth position of one surface of the first inorganic compound layer to the depth position of the other surface of the first inorganic compound layer, in the stacking direction of the stacked body, is defined as the erosion rate E3 of the first inorganic compound layer.

### (3) Refractive Index

The refractive index of the first inorganic compound layer is preferably 1.60 or less, and more preferably 1.50 or less. Meanwhile, the refractive index is, for example, 1.30 or more, and may be 1.40 or more.

Incidentally, the refractive index of each layer in the present descriptions is the refractive index with respect to light with a wavelength of 550 nm. Examples of the method for measuring the refractive index may include a method measuring with an ellipsometer. Examples of the ellipsometer may include “UVSEL” from Jobin Yvon and “DF1030R” from Techno-Synergy, Inc.

In the present disclosure, the refractive index of the first inorganic compound layer is preferably less than the refractive index of the second inorganic compound layer. The reason therefor is to reduce the reflectance of the stacked body in the present disclosure.

### (4) Thickness

The thickness of the first inorganic compound layer is not particularly limited, and is preferably 30 nm or more and 200 nm or less, and more preferably 50 nm or more and 150 nm or less.

Here, the thickness of each layer in the present descriptions may be the average value of the thickness of arbitrary 10 points obtained by measuring from the thickness directional cross-section of the stacked body for a display device by observing with a transmission electron microscope (TEM), a scanning electron microscope (SEM) or a scanning transmission electron microscope (STEM).

### (5) Method for Forming

The first inorganic compound layer may be formed, for example, by selecting particles with the desired refractive index from the low refractive index particles, and using a physical vapor deposition (PVD) method such as vacuum vapor deposition, sputtering and ion plating method. Among them, the vacuum deposition method is preferable from the viewpoint of productivity (deposition rate).

### 2.2 Second Inorganic Compound Layer

The second inorganic compound layer is a layer placed between the first inorganic compound layer and the hard coating layer. The second inorganic compound layer is in direct contact with the first inorganic compound layer and the hard coating layer.

The second inorganic compound layer 3 may be a single layer film as shown in FIG. 1, and may be a multilayer film as shown in FIG. 2. The second inorganic compound layer 3 in FIG. 2 includes two layers of an upper layer film 3a in direct contact with the first inorganic compound layer 2, and a lower layer film 3b in direct contact with the hard coating layer 4.

In the second inorganic compound layer, the first inorganic compound layer side surface may be a surface subjected to a surface treatment, and may be a surface not subjected to a surface treatment. When the second inorganic compound layer is a multilayer film, “the first inorganic compound layer side surface of the second inorganic compound layer” means the surface of the most first inorganic compound layer side inorganic compound film, among the second inorganic compound layers.

Examples of the surface treatment may include the methods described in “1. Erosion rate” above. In particular, plasma treatment is preferable. Examples of the plasma treatment conditions may include plasma discharge power and glow discharge pressure. In the present invention, as for the plasma treatment, for example, the stronger the plasma treatment, the better the close adhesiveness, and the lower the erosion rate E1 at the first interface A.

### (1) Second Inorganic Compound

The second inorganic compound constituting the second inorganic compound layer is not particularly limited, and in particular, material with higher refractive index than the first inorganic compound is preferable. The reason therefor is to obtain low reflectance in combination with the first inorganic compound layer. Examples of the second inorganic compound constituting the second inorganic compound layer may include inorganic oxides such as aluminum oxides, zirconium oxides, silicon oxides, hafnium oxides, tantalum oxides, cerium oxides, titanium oxides, zinc oxides, magnesium oxides, yttrium oxides and niobium oxides.

The average composition of the aluminum oxide is represented by AlOx, and in the formula, “x” may satisfy 0 <x≤1.5, preferably Al₂O₃. The average composition of the zirconium oxide is represented by ZrOx, and in the formula, “x” may satisfy 0<x≤2, preferably ZrO₂. The average composition of the niobium oxide is represented by NbOx, and in the formula, “x” may satisfy 0<x≤2.5, preferably Nb₂O₅.

The second inorganic compound layer is preferably a vapor-deposition film. In particular, it is preferably an aluminum oxide (alumina) deposition film, a zirconium oxide deposition film, and a niobium oxide deposition film. The second inorganic compound layer may be a single film formed by one time of the vapor deposition, and may be a multilayered film formed by multiple times of the vapor depositions. When the second inorganic compound layer is a multilayer film, films having the same composition may be combined, and films having different compositions may be combined.

Also, when the second inorganic compound layer is a single layer film, although the inorganic compound included in the second inorganic compound layer is preferably one type, a plurality type of the inorganic compounds may be included. In the case of a multilayer film, although the inorganic compound included in each film is preferably one type, a plurality type of the inorganic compounds may be included.

### (2) Refractive Index

The refractive index of the second inorganic compound layer is preferably 1.60 or more, and more preferably 1.80 or more. Meanwhile, the refractive index is, for example, 3.00 or less, and may be 2.50 or less.

When the second inorganic compound layer is a multilayer film, the refractive index refers to the refractive index of each film. When the second inorganic compound layer is a multilayer film, it may include a multilayer film with different refractive indexes. In this case, in the second inorganic compound layer, from the hard coating layer side toward the first inorganic compound layer (low refractive index layer), a medium refractive index layer and a high refractive index layer may be stacked in this order, or a high refractive index layer, a low refractive index layer, and a high refractive index layer may be stacked in this order.

### (3) Thickness

The thickness of the second inorganic compound layer is not particularly limited, and the thickness is preferably 20 nm or more and 300 nm or less, and more preferably 30 nm or more and 270 nm or less.

When the second inorganic compound layer is a multilayer film, the thickness of the second inorganic compound layer refers to the thickness of the multilayer film constituting the second inorganic compound layer as a whole. When the second inorganic compound layer is a multilayer film, the thickness of each film is, for example, 10 nm or more and 150 nm or less, and preferably 15 nm or more and 130 nm or less.

### (4) Method for Forming

The second inorganic compound layer may be formed, for example, by selecting particles with the desired refractive index from the high refractive index particles, and using a physical vapor deposition (PVD) method such as vacuum vapor deposition, sputtering and ion plating method. Among them, the vacuum deposition method is preferable from the viewpoint of productivity (deposition rate).

### 2.3 Inorganic Compound Layer

In the present disclosure, the total thickness of the inorganic compound layers included in the stacked body for a display device in the present disclosure is preferably 500 nm or less, and more preferably 400 nm or less. Meanwhile, the total thickness may be, for example, 40 nm or more, and may be 70 nm or more. When the total thickness is too thick, the bending resistance of the stacked body for a display device may be deteriorated. The total thickness of the inorganic compound layers usually refers to the total thickness of the first inorganic compound layer and the second inorganic compound layer.

### 3. Hard Coating Layer

The stacked body for a display device in the present disclosure includes a hard coating layer between the second inorganic compound layer and the substrate layer. In the present disclosure, the stacked body for a display device as a whole has excellent bending resistance since the erosion rate E2 at a second interface that is an interface between the second inorganic compound layer and the hard coating layer, is different from the erosion rate E1 at a first interface in the range described above. Also, by placing the hard coating layer, abrasion resistance may be improved. Particularly, when the substrate layer is a resin substrate, the abrasion resistance may be effectively improved by placing the hard coating layer.

In the hard coating layer, the second inorganic compound layer side surface may be a surface subjected to a surface treatment, and may be a surface not subjected to a surface treatment. Examples of the surface treatment may include the methods described in “1. Erosion rate” above. In particular, plasma treatment is preferable. Examples of the plasma treatment conditions may include plasma discharge power and glow discharge pressure. In the present invention, as for the plasma treatment, for example, the stronger the plasma treatment, the better the close adhesiveness, and the lower the erosion rate E2 at the second interface B.

### (1) Material

As a material of the hard coating layer, for example, an organic material, an inorganic material, and an organic-inorganic composite material may be used. Among the above, the material of the hard coating layer is preferably an organic material. Specifically, the hard coating layer preferably includes a cured product of a resin composition including a polymerizable compound. The cured product of a resin composition including a polymerizable compound may be obtained by carrying out a polymerization reaction of a polymerizable compound, by a known method using a polymerization initiator if necessary. The polymerizable compound includes at least one polymerizable functional group in the molecule. As the polymerizable compound, for example, at least one type of radical polymerizable compound and cation polymerizable compound may be used.

The radical polymerizable compound is a compound including a radical polymerizable group. Examples of the radical polymerizable group included in the radical polymerizable compound may include a group including a carbon-carbon unsaturated double bond, and specific examples thereof may include a vinyl group and a (meth) acryloyl group. The number of radical polymerizable groups included in one molecule of the radical polymerizable compound is preferably two or more, and more preferably three or more.

Among the above, from the viewpoint of high reactivity, the radical polymerizable compound is preferably a compound including a (meth)acryloyl group. For example, a polyfunctional (meth)acrylate monomer and oligomer having a molecular weight of several hundred to several thousand, and including several (meth)acryloyl groups in the molecule may be preferably used; such as those referred to as urethane (meth)acrylate, polyester (meth)acrylate, epoxy (meth)acrylate, melamine (meth)acrylate, polyfluoroalkyl (meth)acrylate, and silicone (meth)acrylate; or a polyfunctional (meth)acrylate polymer including two or more (meth)acryloyl groups on the side chain of an acrylate polymer may also be preferably used. Among the above, a polyfunctional (meth)acrylate monomer including two or more (meth)acryloyl groups in one molecule may be preferably used. By including a cured product of the polyfunctional (meth)acrylate monomer, the abrasion resistance may be improved. Further, the close adhesiveness may also be improved. Also, a polyfunctional (meth)acrylate oligomer or polymer including two or more (meth)acryloyl groups in one molecule may also be preferably used. By including a cured product of the polyfunctional (meth)acrylate oligomer or polymer, the abrasion resistance may be improved. Further, the bending resistance and close adhesiveness may also be improved.

Incidentally, in the present specification, (meth)acryloyl represents each of acryloyl and methacryloyl, and (meth)acrylate represents each of acrylate and methacrylate.

The cation polymerizable compound is a compound including a cation polymerizable group. Examples of the cation polymerizable group included in the cation polymerizable compound may include an epoxy group, an oxetanyl group, and a vinyl ether group. Incidentally, when the cation polymerizable compound includes two or more cation polymerizable groups, these cation polymerizable groups may be the same, and may be different from each other.

Also, the hard coating layer may include an antistatic agent. The stacked body for a display device may be imparted with an antistatic property. The hard coating layer may further include an additive if necessary. The additive is appropriately selected according to the function imparted to the hard coating layer, and is not particularly limited. Examples thereof may include inorganic particles, organic particles, ultraviolet absorbers, infrared absorbers, antifoulants, antiglare agents, leveling agents, surfactants, easy lubricants, various sensitizers, flame retardants, adhesive imparting agents, polymerization inhibitors, antioxidants, light stabilizers and surface modifiers.

Also, in the present disclosure, in order to obtain both of the bending resistance and the close adhesiveness to the second inorganic compound layer, the material of the hard coating layer is preferably an organic-inorganic material including the followings in a combination: radical polymerizable compound including at least one of an urethane (methyl) acrylate and a polyfunctional (meth)acrylate monomer; and reactive inorganic particles including a reactive functional group capable of forming a covalent bond with the radical polymerizable compound, and further preferably includes an adhesive imparting agent as an additive, together with the above. Examples of the reactive inorganic particles may include silica including a reactive functional group. Also, examples of the reactive functional group may include a vinyl group, a (meth)acryloyl group, an allyl group, an epoxy group and a silanol group.

### (2) Thickness

The thickness of the hard coating layer may be appropriately selected according to the function of the hard coating layer and the use application of the stacked body for a display device. The thickness of the hard coating layer is preferably, for example, 0.5 μm or more and 50 μm or less, more preferably 1.0 μm or more and 40 μm or less, further preferably 1.5 μm or more and 30 μm or less, and particularly preferably 2 μm or more and 20 μm or less. When the thickness of hard coating layer is in the above range, sufficient hardness as the hard coating layer may be obtained.

### (3) Method for Forming

Examples of a method for forming a hard coating layer may include a method wherein the substrate layer is coated with a resin composition for a hard coating layer including the polymerizable compound, and cured.

### 4. Substrate Layer

The substrate layer in the present disclosure is a member configured to support the hard coating layer, second inorganic compound layer, and first inorganic compound layer. The substrate layer is not particularly limited as long as it has transparency; and examples thereof may include a resin substrate, and a glass substrate.

### (1) Resin Substrate

The resin constituting the resin substrate is not particularly limited as long as it is able to obtain a resin substrate having transparency; and examples thereof may include a polyimide based resin, a polyamide based resin, and a polyester based resin. Examples of the polyimide based resin may include polyimide, polyamideimide, polyetherimide, and polyesterimide. Examples of the polyester based resin may include polyethylene terephthalate, polypropylene terephthalate, polybutylene terephthalate, and polyethylene naphthalate.

### (2) Glass Substrate

The glass constituting the glass substrate is not particularly limited as long as it has transparency; and examples thereof may include silicate glass and silica glass. Among them, borosilicate glass, aluminosilicate glass, and aluminoborosilicate glass are preferable, and alkali-free glass is more preferable. Examples of the commercial products of the glass substrate may include ultra-thin plate glass G-Leaf from Nippon Electric Glass Co. Ltd., and ultra-thin film glass from Matsunami Glass Ind. Ltd.

Also, the glass constituting the glass substrate is preferably a chemically strengthened glass. The chemically strengthened glass is preferable since it has excellent mechanical strength and may be made thin accordingly. The chemically strengthened glass is typically a glass wherein mechanical properties are strengthened by a chemical method by partially exchanging ionic species, such as by replacing sodium with potassium, in the vicinity of the surface of glass, and includes a compressive stress layer on the surface.

Examples of the glass constituting the chemically strengthened glass substrate may include aluminosilicate glass, soda-lime glass, borosilicate glass, lead glass, alkali barium glass, and aluminoborosilicate glass.

Examples of the commercial products of the chemically strengthened glass substrate may include Gorilla Glass from Corning Incorporated, Dragontrail from AGC Inc., and chemically strengthened glass from Schott Ag.

### (3) Constitution of Substrate Layer

The thickness of the substrate layer is not particularly limited as long as it has a thickness capable of having flexibility, and is appropriately selected according to the type of the substrate layer.

The thickness of the resin substrate is preferably, for example, 10 μm or more and 100 μm or less, and more preferably 25 μm or more and 80 μm or less. When the thickness of the resin substrate is in the above range, excellent flexibility may be obtained, and at the same time, sufficient hardness may be obtained. It is also possible to suppress curling of the stacked body for a display device. Furthermore, it is preferable in terms of reducing the weight of the stacked body for a display device.

The thickness of the glass substrate is preferably, for example, 200 μm or less, more preferably 15 μm or more and 100 μm or less, further preferably 20 μm or more and 90 μm or less, and particularly preferably 25 μm or more and 80 μm or less. When the thickness of the glass substrate is in the above range, excellent flexibility may be obtained, and at the same time, sufficient hardness may be obtained. It is also possible to suppress curling of the stacked body for a display device. Furthermore, it is preferable in terms of reducing the weight of the stacked body for a display device.

### 5. Other Constitution

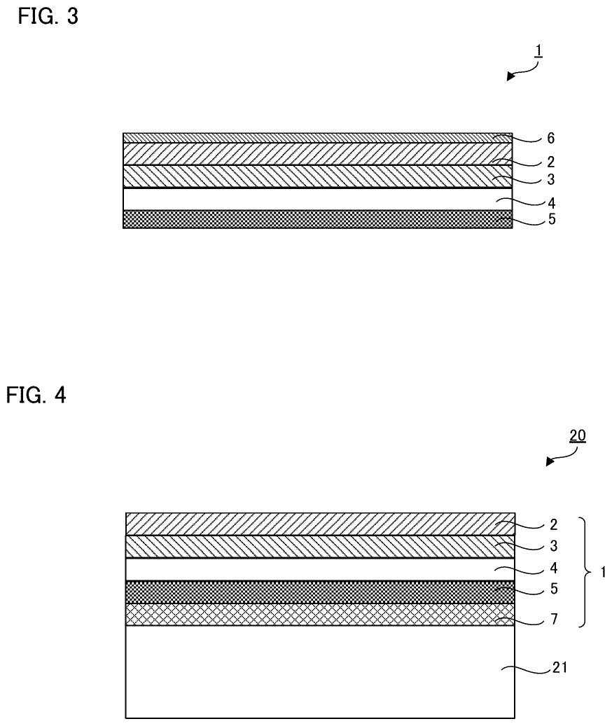

FIG. 3 is a schematic cross-sectional view illustrating another example of a stacked body for a display device of the present disclosure. As shown in FIG. 3, the stacked body for a display device 1 of the present disclosure preferably includes fluorine-containing layer 6 on the surface of the first inorganic compound layer 2 that is opposite side to the second inorganic compound layer 3 side.

### (1) Fluorine-Containing Layer

The stacked body for a display device in the present disclosure preferably includes a fluorine-containing layer including a fluorine atom on the surface of the first inorganic compound layer that is opposite side to the second inorganic compound layer side. Among the above, the fluorine-containing layer is preferably placed on the outermost surface in the stacked body for a display device. The fluorine-containing layer has only to include a fluorine atom, and by including the fluorine atom, abrasion resistance may be imparted to the stacked body for a display device.

Specifically, the dynamic friction coefficient of the fluorine-containing layer side surface of the stacked body for a display device may be set to a predetermined range. The dynamic friction coefficient of the fluorine-containing layer side surface of the stacked body for a display device in the present disclosure is preferably 0.01 or more and 0.30 or less, and more preferably 0.03 or more and 0.20 or less. When the dynamic friction coefficient is the above value of less, the sliding property of the surface is improved so that abrasion resistance is further improved.

The dynamic friction coefficient may be measured by a method compliant with JIS K7125: 1999 (Friction Coefficient Test Method). The method for measuring a dynamic friction coefficient may be carried out using a Variable Normal Load Friction and Wear Measurement System (Heidon type HHS2000 from Shinto Scientific Co., Ltd.) with a 2 cm×2 cm cashmere felt under the conditions of load of 200 g and speed of 5 mm/sec. The average value of the measured value measured at five points of different locations on the fluorine-containing layer side surface of the stacked body for a display device is regarded as the dynamic friction coefficient value.

The fluorine-containing layer is not particularly limited as long as it includes a fluorine atom. The fluorine-containing layer may include, for example, a fluorine compound, may include a fluorine compound and resin, and may include fluorine resin. As the fluorine compound, for example, those knowns as a fluorine based antifoulant, a fluorine based leveling agent and a fluorine based surfactant may be used. Examples of the fluorine compound may include an organic fluorine compound, and specific examples thereof may include a perfluorocompound. Examples of the perfluorocompound may include a perfluorocompound including, for example, a perfluoropolyether group, a perfluoroalkylene group, and a perfluoroalkyl group. The perfluoroalkylene group and perfluoroalkyl group may be linear or branched. One type of the fluorine compound may be used alone, and two types or more may be used as a mixture.

Also, the fluorine compound is preferably bonded to a resin component. When the fluorine compound is bonded to the resin component, the bleed-out of the fluorine compound may be suppressed, and the abrasion resistance and antifouling properties may be maintained over a long period of time.

Since the fluorine compound is preferably bonded to a resin component, a fluorine compound including a reactive functional group is preferably used. That is, the fluorine-containing layer preferably includes a cured product of a resin composition including a fluorine compound including a reactive functional group and the polymerizable compound described below. Examples of the reactive functional group may include ethylenically unsaturated bonding groups such as a (meth)acryloyl group, a vinyl group, and an allyl group; an epoxy group; and an oxetanyl group.

The number of the reactive functional groups included in the fluorine compound may be 1 or more, and preferably 2 or more. By using the fluorine compound including 2 or more reactive functional groups, abrasion resistance may be improved.

Also, the fluorine compound may include silicon. That is, the fluorine-containing layer may include fluorine and silicon. Examples of the fluorine compound including silicon may include a fluorine compound including a siloxane bond in the molecule. By using the fluorine compound including a siloxane bond, sliding properties may be improved, and abrasion resistance may be improved.

The fluorine compound is preferably, for example, a fluorine compound including a reactive functional group; or a fluorine compound including a reactive functional group and silicon.

Examples of the fluorine compound including a reactive functional group may include a fluorine including monomer including an ethylenically unsaturated bond; a fluorine including polymer or oligomer including a fluoroalkylene group on the main chain; and a fluorine including polymer or oligomer including a fluoroalkylene group or fluoroalkyl group on the main chain and side chain. For fluorine compound including a reactive functional group, refer to, for example, Japanese Patent Application Laid-Open (JP-A) No. 2017-19247.

Examples of the fluorine compound including a reactive functional group and silicon may include a silicone including vinylidene fluoride copolymer obtained by reacting an organic silicone including a reactive functional group in the molecule with the fluorine compound including a reactive functional group.

Also, for the fluorine compound including a reactive functional group and silicon, for example, a fluorine compound including a reactive functional group and a perfluoropolyether group, among the above, a fluorine compound including a silane unit including a reactive functional group and a silane unit including a perfluoropolyether group is also preferably used. For such fluorine compound, refer to, for example, WO2012/157682.

In the present disclosure, the fluorine-containing layer may be a layer including a fluorine compound and resin. For example, when the fluorine-containing layer includes a fluorine compound and resin, examples of the resin may include a cured product of a polymerizable compound. The cured product of a polymerizable compound may be obtained by carrying out a polymerization reaction of a polymerizable compound, by a known method using a polymerization initiator according to the needs.

Also, for example, when the fluorine-containing layer includes fluorine resin, examples of the fluorine resin may include a cured product of a polymerizable compound including fluorine. The cured product of a polymerizable compound including fluorine may be obtained by carrying out a polymerization reaction of a polymerizable compound including fluorine, by a known method using a polymerization initiator according to the needs.

The polymerizable compound including fluorine includes at least one polymerizable functional group in the molecule. As the polymerizable compound including fluorine, for example, at least one type of radical polymerizable compound and cation polymerizable compound may be used. Also, as the polymerizable compound including fluorine, for example, any one of fluorine-containing monomers, oligomers, and polymers may be used.

The fluorine-containing layer may include an additive such as inorganic particles, organic particles, ultraviolet absorbers, antioxidants, light stabilizers, antiglare agents, leveling agents, surfactants, easy lubricants, various sensitizers, flame retardants, adhesive imparting agents, polymerization inhibitor, and surface modifiers, if necessary.

In the present disclosure, the fluorine-containing layer may be a single layer film, and may be a multilayer film.

The thickness of the fluorine-containing layer is not particularly limited, and it is, for example, 0.5 μm or more and 50 μm or less, may be 1.0 μm or more and 40 μm or less, and may be 1.5 μm or more and 30 μm or less. When the thickness of the fluorine-containing layer is too thin, the surface hardness of the fluorine-containing layer may decrease so that the abrasion resistance may decrease. Also, when the thickness of the fluorine-containing layer is too thick, the flexibility may be deteriorated.

Meanwhile, in the present disclosure, when the stacked body for a display device exhibits low reflectivity by including the first inorganic compound layer and the second inorganic compound layer, the thickness of the fluorine-containing layer is preferably relatively thin. The reason therefor is to suppress the influence on the thin film interference. The thickness of the fluorine-containing layer in this case is preferably, for example, 1 nm or more and 30 nm or less, more preferably 2 nm or more and 20 nm or less, and further preferably 3 nm or more and 10 nm or less.

Also, a method for forming a fluorine-containing layer may be appropriately selected according to the material, and examples thereof may include a vacuum deposition method; a sputtering method; and a method wherein the first inorganic compound layer is coated with a composition for a fluorine-containing layer, and cured.

### (2) Adhesive Layer for Adhesion

The stacked body for a display device in the present disclosure may include an adhesive layer for adhesion on the surface of the substrate layer that is opposite side to a hard coating layer side surface. The stacked body for a display device may be adhered to, for example, a display panel via the adhesive layer for adhesion.

The adhesive used for the adhesive layer for adhesion is not particularly limited as long as it is an adhesive having transparency, and is capable of adhering the stacked body for a display device to, for example, a display panel. Examples thereof may include a thermosetting adhesive, an ultraviolet curable adhesive, a two-component curable adhesive, a thermal fusion adhesive, and a pressure-sensitive adhesive (so-called tackiness agent).

The thickness of the adhesive layer for adhesion is preferably, for example, 10 μm or more and 100 μm or less, more preferably 25 μm or more and 80 μm or less, and further preferably 40 μm or more and 60 μm or less. When the thickness of the adhesive layer for adhesion is too thin, the stacked body for a display device and the display panel may not be adhered sufficiently. Meanwhile, when the thickness of the adhesive layer for adhesion is too thick, the flexibility may be deteriorated.

As the adhesive layer for adhesion, for example, an adhesive film may be used. Also, for example, the adhesive layer for adhesion may be formed by coating a supporting body or the substrate layer, for example, with an adhesive composition.

The adhesive layer for adhesion may be a layer with close adhesiveness to the extent that may be peeled off after being adhered to the display panel of a display device; or may be a layer with high close adhesiveness with no intention to be peeled off.

### (3) Interlayer Adhesive Layer

In the stacked body for a display device in the present disclosure, an interlayer adhesive layer may be placed between each layer. The adhesive used for the interlayer adhesive layer may be similar to the adhesive used for the adhesive layer for adhesion.

### 5. Stacked Body for Display Device

### (1) Luminous Reflectance

In the stacked body for a display device in the present disclosure, regarding the incident angle of the light entering from the first inorganic compound layer side, vertically with respect to the first inorganic compound layer surface as 0°, the luminous reflectance of regular reflection light of this incident light, when light is entered with incident angle of 5°, is 2.0% or less. The luminous reflectance of regular reflection light is preferably 1.7% or less, and further preferably 1.5% or less. When the luminous reflectance is too high, it may not be possible to suppress the observer oneself from being reflected in the display region.

Here, the luminous reflectance may be determined according to JIS Z8722: 2009. For the luminous reflectance, the tristimulus values X, Y and Z in the XYZ color system are determined from the reflected spectrum obtained when light, in a wavelength range of 380 nm or more and 780 nm or less, is incident on the first inorganic compound layer side surface of the stacked body for a display device, in conditions of a viewing angle of 2 degree, and standard light C, and the value of Y is regarded as the luminous reflectance. That is, the luminous reflectance refers to the Y value of the CIE1931 standard colorimetric system. The following conditions may be used for measuring the luminous reflectance.

### (Measurement Conditions)

Viewing angle: 2°
Illuminant: C
Light source: tungsten halogen lamp
Measurement wavelength: 0.5 nm interval in the range of 380 nm or more and 780 nm or less
Scan speed: fast
Slit width: 5.0 nm
S/R switch: standard
Auto Zero: carried out at 550 nm after baseline scan

Incidentally, when measuring the luminous reflectance of the stacked body for a display device, black vinyl tape with a width larger than the measured spot area (for example, product name “Yamato Vinyl Tape NO200-19-21” from Yamato Co. Ltd., 19 mm wide) is adhered to the substrate layer side surface of the stacked body for a display device, before measuring, in order to prevent backside reflection. For example, a spectrophotometer may be used as a measurement device for the luminous reflectance, and specifically, “UV-2600” spectrophotometer from Shimadzu Corporation may be used.

### (2) Dynamic Bending Resistance

The stacked body for a display device in the present disclosure has a bending resistance. Specifically, when the dynamic bending test described below is carried out to the stacked body for a display device, it is preferable that a crack or a fracture does not occur in the stacked body for a display device.

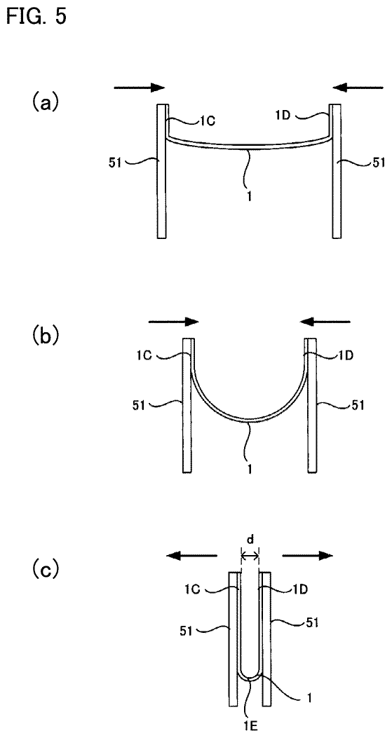

The dynamic bending test is carried out as follows. Firstly, a stacked body for a display device having a size of 20 mm×100 mm is prepared. Then, in the dynamic bending test, as shown in FIG. 5(a), short side portion 1C and short side portion 1D opposing to the short side portion 1C of the stacked body for a display device 1 are respectively fixed by parallelly arranged fixing portions 51. Also, as shown in FIG. 5(a), the fixing portions 51 are movable by sliding in horizontal direction. Then, as shown in FIG. 5(b), by moving the fixing portions 51 so as to be closer to each other, the stacked body for a display device 1 is deformed so as to be folded. Further, as shown in FIG. 5(c), after moving the fixing portions 51 to the position wherein distance “d” between the two opposing short side portions 1C and 1D of the stacked body for a display device 1 fixed by the fixing portions 51 is a predetermined value, the deformation of the stacked body for a display device 1 is dissolved by moving the fixing portions 51 in opposite directions. As shown in FIGS. 5(a) to 5(c), by moving the fixing portions 51, the stacked body for a display device 1 may be folded into 180°. Also, by carrying out the dynamic bending test so that bent portion 1E of the stacked body for a display device 1 does not protrude from the lower end edge of the fixing portions 51, and by controlling the distance when the fixing portions 51 are the closest, distance “d” between the two opposing short side portions 1C and 1D of the stacked body for a display device 1 may be a predetermined value. For example, when the distance “d” between the short side portions 1C and 1D is 10 mm, the outer diameter of the bent portion 1E is regarded as 10 mm.

In the stacked body for a display device in the present disclosure, it is preferable that a crack or a fracture does not occur when the dynamic bending test wherein the stacked body for a display device 1 is folded into 180° so that the distance “d” between the opposing short side portions 1C and 1D of the stacked body for a display device 1 is 10 mm, is carried out repeatedly for 200, 000 times, and it is more preferable that a crack or a fracture does not occur when the dynamic bending test is carried out repeatedly for 500, 000 times. Among the above, it is preferable that a crack or a fracture does not occur when the dynamic bending test wherein the stacked body for a display device is folded into 180° so that the distance “d” between the opposing short side portions 1C and 1D of the stacked body for a display device is 6 mm, is carried out repeatedly for 200, 000 times. In the dynamic bending test, the stacked body for a display device may be folded so that the first inorganic compound layer is on the outer side, or the stacked body for a display device may be folded so that the first inorganic compound layer is on the inner side; and in either of these cases, it is preferable that a crack or a fracture does not occur in the stacked body for a display device.

### (3) Total Light Transmittance and Haze

The total light transmittance of the stacked body for a display device in the present disclosure is preferably, for example, 85% or more, more preferably 88% or more, and further preferably 90% or more. When the total light transmittance is high as described above, the stacked body for a display device may have good transparency.

Here, the total light transmittance of the stacked body for a display device may be measured according to JIS K7361-1:1999, and may be measure with, for example, a haze meter HM150 from Murakami Color Research Laboratory Co., Ltd.

The haze of the stacked body for a display device in the present disclosure is preferably, for example, 5% or less, more preferably 2% or less, and further preferably 18 or less. When the haze is low as described above, the stacked body for a display device may have good transparency.

Here, the haze of the stacked body for a display device may be measured according to JIS K-7136:2000, and may be measure with, for example, a haze meter HM150 from Murakami Color Research Laboratory Co., Ltd.

### 6. Use Application

The stacked body for a display device in the present disclosure may be used as a front panel placed on the observer side than the display panel in a display device. Since the stacked body for a display device in the present disclosure has excellent bending resistance, it may be preferably used as a front panel in a flexible display device such as a foldable display, a rollable display, and a bendable display. Particularly, the stacked body for a display device in the present disclosure is suitably used for the front panel in a foldable display, since it improves the bending resistance.

The thickness of the stacked body for a display device in the present disclosure is preferably, for example, 10 μm or more and 500 μm or less, more preferably 20 μm or more and 400 μm or less, and further preferably 30 μm or more and 300 μm or less. When the thickness of the stacked body for a display device is in the above range, the flexibility may be improved.

Also, the stacked body for a display device in the present disclosure may be used as a front panel in a display device such as smart phones, tablet terminals, wearable terminals, personal computers, televisions, digital signages, public information displays (PIDs), and car mounted displays.

### B. Display Device

The display device in the present disclosure comprises: a display panel, and the stacked body for a display device described above placed on an observer side of the display panel.

FIG. 4 is a schematic cross-sectional view illustrating an example of a display device in the present disclosure. As shown in FIG. 4, display device 20 comprises display panel 21, and the stacked body for a display device 1 placed on an observer side of the display panel 21. In the display device 20, the stacked body for a display device 1 and the display panel 21 may be adhered via, for example, the adhesive layer for adhesion 7 of the stacked body for a display device 1.

Since the flexible display device in the present disclosure has excellent bending resistance, display defects are suppressed even if it is repeatedly bent.

When the stacked body for a display device in the present disclosure is placed on the surface of the display device, it is placed so that the first inorganic compound layer is on the outer side, and the substrate layer is on the inner side.

The method for placing the stacked body for a display device in the present disclosure on the surface of the display device is not particularly limited, and examples thereof may include a method via an adhesive layer.

Examples of the display panel in the present disclosure may include a display panel used for a display device such as an organic EL display device, and a liquid crystal display device.

The display device in the present disclosure may include a touch-sensitive panel member between the display panel and the stacked body for a display device.

Among the above, the display device in the present disclosure is preferably a flexible display device such as a foldable display, a rollable display, and a bendable display.

Also, the display device in the present disclosure is preferably foldable. That is, the display device in the present disclosure is preferably a foldable display.

### EXAMPLES

The present disclosure is hereinafter explained in further details with reference to Examples and Comparative Examples.

### Examples 1 to 3 and Comparative Example 1

Firstly, a resin composition for a hard coating layer was obtained by compounding each component so as to be the composition shown below.

### (Composition of Resin Composition for Hard Coating Layer):

Urethane acrylate (product name “UA-33H” from Shin-Nakamura Chemical Co., Ltd.): 64 parts by mass.
Pentaerythritol acrylate (product name “ATM-4PL” from Shin-Nakamura Chemical Co., Ltd.): 36 parts by mass
Polymerization initiator (1-hydroxycyclohexylphenyl ketone, product name “Omnirad184” from IGM Resins B. V.): 4 parts by mass
Adhesive imparting agent (product name “BYK-4509” from BYK-Chemie Japan Co., Ltd.): 0.3 parts by mass (solid content 100% conversion value)
Silica particle (silica particles including an epoxy group as a reactive group, average primary particle size: 12 nm, from Nissan Chemical Corporation): 70 parts by mass (solid content 100% conversion value)·
Methyl isobutyl ketone: 220 parts by mass

### (Formation of Hard Coating Layer)

Then, using a polyamideimide film (product name “CPI” from Kolon Industries) having a thickness of 50 μm as a substrate layer, a coating film was formed on the substrate layer by applying the resin composition for a hard coating layer with a bar coater. Thereafter, the coating film was heated at 80° C. for 1 minute to evaporate the solvent in the coating film, and the coating film was cured by irradiating ultraviolet rays with an ultraviolet ray irradiation device (light source H bulb from Fusion UV Systems Japan K. K.) under the condition of an oxygen concentration of 100 ppm or less so that the integrated light amount was 400 mJ/cm² to form a hard coating layer with a thickness of 3.0 μm.

### (Formation of Inorganic Compound Layer)

Then, the plasma treatment was carried out on the surface of the obtained hard coating layer under the conditions shown in Table 1. Then, a second inorganic compound layer was formed on the surface treatment subjected surface of the hard coating layer, by a vacuum deposition method, using the constituent materials shown in Table 1. A first inorganic compound layer was formed on the second inorganic compound layer, by a vacuum deposition method, using the constituent materials shown in Table 1.

The constituent materials, thickness, refractive index, and plasma treatment conditions of the first inorganic compound layer and the second inorganic compound layer are shown in Table 1.

### (Formation of Fluorine-Containing Layer)

Then, a fluorine-containing layer with a thickness of 7 nm was formed by vacuum depositing a fluorine compound (product name “Optool UD120” from Daikin Industries, Ltd.). As described above, a stacked body including a substrate layer, a hard coating layer, a second inorganic compound layer, a first inorganic compound layer and a fluorine-containing layer, in this order, was obtained.

### Example 4

A stacked body was obtained in the same manner as in Example 1 except that the plasma treatment was not carried out on the surface of the hard coating layer.

### Examples 5 to 8 and Comparative Example 2

A hard coating layer was formed on the substrate layer in the same manner as in Example 1. Then, a second inorganic compound layer was formed on the hard coating layer by a vacuum deposition method using the constituent materials shown in Table 1. Then, the plasma treatment was carried out on the surface of the second inorganic compound layer under the conditions shown in Table 1. Then, a first inorganic compound layer was formed on the surface treatment subjected surface of the second inorganic compound layer, by a vacuum deposition method, using the constituent materials shown in Table 1. Then, a fluorine-containing layer was formed in the same manner as in Example 1, and obtained a stacked body including a substrate layer, a hard coating layer, a second inorganic compound layer, a first inorganic compound layer and a fluorine-containing layer, in this order.

### Example 9

A hard coating layer was formed on the substrate layer in the same manner as in Example 1. Then, the plasma treatment was carried out on the surface of the obtained hard coating layer under the conditions shown in Table 1. Then, a lower layer film (ZrO₂) and an upper layer film (Nb₂O₅) of the second inorganic compound layer were formed on the surface treatment subjected surface of the hard coating layer, by a vacuum deposition method, using the constituent materials shown in Table 1.

Then, a first inorganic compound layer was formed on the second inorganic compound layer using the constituent materials shown in Table 1. Then, a fluorine-containing layer was formed in the same manner as in Example 1, and obtained a stacked body including a substrate layer, a hard coating layer, a second inorganic compound layer, a first inorganic compound layer and a fluorine-containing layer, in this order.

### Comparative Examples 3 to 5

A hard coating layer was formed on the substrate layer in the same manner as in Example 1. Then, a lower layer film (ZrO₂) and an upper layer film (Nb₂O₅) of the second inorganic compound layer in Comparative Examples 3 and Comparative Example 4, and a lower layer film (Al₂O₃), an intermediate layer film (ZrO₂) and an upper layer film (Nb₂O₅) of the second inorganic compound layer in Comparative Example 5 were formed on the hard coating layer, by a vacuum deposition method, using the constituent materials shown in Table 1. Then, the plasma treatment was carried out on the surface of the second inorganic compound layer under the conditions shown in Table 1. Then, a first inorganic compound layer was formed on the surface treatment subjected surface of the second inorganic compound layer using the constituent materials shown in Table 1. Then, a fluorine-containing layer was formed in the same manner as in Example 1, and obtained a stacked body including a substrate layer, a hard coating layer, a second inorganic compound layer, a first inorganic compound layer and a fluorine-containing layer, in this order.

TABLE 1

| | First inorganic compound layer | | | | | | | | | |
|---|---|---|---|---|---|---|---|---|---|---|
| | | | | Surface treatment to | | | | | | |
| | | | | second inorganic | Second inorganic compound layer | | | | | Surface treatment to |
| | | Thickness | Refractive | compound layer | Number | | | Thickness | Refractive | hard coating layer |
| | Material | [nm] | index | (plasma treatment) | of layers | | Material | [nm] | index | (plasma treatment) |
| Ex. 1 | SiO₂ | 80 | 1.47 | — | 1 | layer | ZrO₂ | 90 | 2.00 | Output 300 W, 90 sec |
| Ex. 2 | SiO₂ | 80 | 1.47 | — | 1 | layer | ZrO₂ | 90 | 2.00 | Output 500 W, 90 sec |
| Ex. 3 | SiO₂ | 80 | 1.47 | — | 1 | layer | ZrO₂ | 90 | 2.00 | Output 100 W, 90 sec |
| Ex. 4 | SiO₂ | 80 | 1.47 | — | 1 | layer | ZrO₂ | 90 | 2.00 | — |
| Ex. 5 | SiO₂ | 80 | 1.47 | Output 300 W, 90 sec | 1 | layer | ZrO₂ | 90 | 2.00 | — |
| Ex. 6 | SiO₂ | 80 | 1.47 | Output 100 W, 90 sec | 1 | layer | ZrO₂ | 90 | 2.00 | — |
| Ex. 7 | SiO₂ | 80 | 1.47 | Output 500 W, 90 sec | 1 | layer | ZrO₂ | 90 | 2.00 | — |
| Ex. 8 | SiO₂ | 80 | 1.47 | Output 500 W, 90 sec | 1 | layer | ZrO₂ | 130 | 2.00 | — |
| Ex. 9 | SiO₂ | 90 | 1.47 | — | 2 | layers | ZrO₂/Nb₂O₅ | 90/35 | 2.00/2.30 | Output 300 W, 90 sec |
| Comp. | SiO₂ | 80 | 1.47 | — | 1 | layer | ZrO₂ | 90 | 2.00 | Output 500 W, 270 sec |
| Ex. 1 | | | | | | | | | | |
| Comp. | SiO₂ | 80 | 1.47 | Output 500 W, 270 sec | 1 | layer | ZrO₂ | 90 | 2.00 | — |
| Ex. 2 | | | | | | | | | | |
| Comp. | SiO₂ | 80 | 1.47 | Output 500 W, 270 sec | 2 | layers | ZrO₂/Nb₂O₅ | 90/35 | 2.00/2.30 | — |
| Ex. 3 | | | | | | | | | | |
| Comp. | SiO₂ | 80 | 1.47 | Output 500 W, 270 sec | 2 | layers | ZrO₂/Nb₂O₅ | 90/60 | 2.00/2.30 | — |
| Ex. 4 | | | | | | | | | | |
| Comp. | SiO₂ | 80 | 1.47 | Output 500 W, 270 sec | 3 | layers | Al₂O₃/ZrO₂/ | 15/40/75 | 1.64/2.00/2.30 | — |
| Ex. 5 | | | | | | | Nb₂O₅ | | | |

### [Erosion Rate]

For the stacked body for a display device obtained in Examples 1 to 9 and Comparative Examples 1 to 5, the erosion rate E1 at a first interface that is an interface between the first inorganic compound layer and the second inorganic compound layer; and the erosion rate E2 at a second interface that is an interface between the second inorganic compound layer and the hard coating layer were calculated according to the method described in “A. Stacked body for a display device, 1. Erosion rate” above. Further, ΔE1(E2−E1), the difference of these, was calculated. Also, a difference ΔE2(E3−E1) between an erosion rate E3 of the first inorganic compound layer, and the erosion rate E1 at the first interface, was calculated. The results are shown in Table 2.

### (Dynamic Bending Property Evaluation)

A dynamic bending test was respectively carried out for the bending property of the stacked body for a display device obtained in Examples 1 to 9 and Comparative Examples 1 to 5, and the results were evaluated by the following evaluation criteria. The results are shown in Table 2. The dynamic bending test method is herein described, referring to FIG. 5. The following dynamic bending test was carried out to the stacked body to evaluate the bending resistance. Firstly, a stacked body having a size of 20 mm×100 mm was prepared. Then, as shown in FIG. 5(a), short side portion 1C and short side portion 1D, opposing to the short side portion 1C, of the stacked body for a display device 1 were respectively fixed by parallelly arranged fixing portions 51. Then, as shown in FIG. 5(b), by moving the fixing portions 51 so as to be closer to each other, the stacked body for a display device 1 was deformed so as to be folded. Further, as shown in FIG. 5(c), after moving the fixing portions 51 to the position wherein distance “d” between the two opposing short side portions 1C and 1D of the stacked body for a display device 1 fixed by the fixing portions 51 was a predetermined value, the deformation of the stacked body for a display device 1 was dissolved by moving the fixing portions 51 in opposite directions. As shown in FIGS. 5(a) to (c), by moving the fixing portions 51, the stacked body for a display device 1 was folded into 180° repeatedly. When doing so, the distance “d” between the two opposing short side portions 1C and 1D of the stacked body for a display device 1 was 6 mm ($6 mm dynamic bending test), or 10 mm ($10 mm dynamic bending test). Also, the stacked body was bent so that the fluorine compound layer was outward. The results of the dynamic bending test were evaluated based on the following criteria.

### Evaluation Criteria

A′: Passed (in the dynamic bending test of φ6 mm with the first inorganic compound layer side outward, no fracture and no crack occurred even after bending repeatedly for 200, 000)
A: Passed (in the dynamic bending test of φ10 mm with the first inorganic compound layer side outward, no fracture and no crack occurred even after bending repeatedly for 200, 000)
B: Fail (in the dynamic bending test of φ10 mm with the first inorganic compound layer side outward, a fracture or a crack occurred while being bended repeatedly for 200, 000)
   (Visibility at Bent Portion after Bending Test)

After the dynamic bending test, the stacked body for a display device was adhered to a screen-displayed tablet display, and the visibility of the bent portion was checked under fluorescent light, and evaluated by the following evaluation criteria.

### Evaluation Criteria

A: Pass (10 out of 10 people were able to observe without problems)
B: Pass (7 or more and 9 or less out of 10 people were able to observe without problems)
C: Fail (4 or more and 6 or less people out of 10 people were able to observe without problems)
D: Fail (less than 4 people out of 10 people were able to observe without problems)

### (Luminous Reflectance)

The luminous reflectance of the stacked body for a display device obtained in Examples 1 to 9 and Comparative Examples 1 to 5 was respectively measured by the method described in “5. Stacked body for display device, (1) Luminous reflectance”. The results are shown in Table 2.

TABLE 2

| | | | | | | Dynamic | | |
|---|---|---|---|---|---|---|---|---|
| | | | | | | bending | | Visibility |
| | | | | | | property | | at bent |
| | | | | | | Bent with | Luminous | portion |
| | | | | | | functional | reflectance | after |
| | Erosion rate [μm/g] | | | | | layer on | [%] 5° | bending |
| | E1 | E2 | ΔE1(E2 − E1) | E3 | ΔE2(E3 − E1) | outer side | reflection | test |
| Ex. 1 | 7.5 × 10⁻³ | 2.1 × 10⁻³ | −5.4 × 10⁻³ | 2.0 × 10⁻² | 1.3 × 10⁻² | A′ | 1.1 | A |
| Ex. 2 | 8.7 × 10⁻³ | 1.3 × 10⁻³ | −7.4 × 10⁻³ | 2.1 × 10⁻² | 1.2 × 10⁻² | A′ | 1.1 | A |
| Ex. 3 | 7.3 × 10⁻³ | 2.5 × 10⁻³ | −4.8 × 10⁻³ | 2.1 × 10⁻² | 1.4 × 10⁻² | A′ | 1.1 | A |
| Ex. 4 | 8.6 × 10⁻³ | 6.3 × 10⁻³ | −2.3 × 10⁻³ | 2.2 × 10⁻² | 1.3 × 10⁻² | A′ | 1.1 | A |
| Ex. 5 | 3.1 × 10⁻³ | 3.4 × 10⁻² | 3.1 × 10⁻² | 2.1 × 10⁻² | 1.8 × 10⁻² | A | 1.1 | A |
| Ex. 6 | 4.6 × 10⁻³ | 1.9 × 10⁻² | 1.4 × 10⁻² | 2.1 × 10⁻² | 1.6 × 10⁻² | A | 1.1 | A |
| Ex. 7 | 1.6 × 10⁻³ | 7.8 × 10⁻² | 7.6 × 10⁻² | 2.0 × 10⁻² | 1.8 × 10⁻² | A | 1.1 | A |
| Ex. 8 | 1.6 × 10⁻³ | 7.8 × 10⁻² | 7.6 × 10⁻² | 2.1 × 10⁻² | 1.9 × 10⁻² | A | 1.8 | B |
| Ex. 9 | 8.9 × 10⁻³ | 2.6 × 10⁻³ | −6.3 × 10⁻³ | 2.1 × 10⁻² | 1.2 × 10⁻² | A′ | 0.3 | A |
| Comp. Ex. 1 | 1.9 × 10⁻² | 8.7 × 10⁻⁴ | −1.8 × 10⁻² | 2.1 × 10⁻² | 2.0 × 10⁻³ | B | 1.1 | C |
| Comp. Ex. 2 | 1.7 × 10⁻³ | 1.5 × 10⁻¹ | 1.5 × 10⁻¹ | 2.2 × 10⁻² | 2.0 × 10⁻² | B | 1.1 | C |
| Comp. Ex. 3 | 1.5 × 10⁻³ | 1.6 × 10⁻¹ | 1.6 × 10⁻¹ | 2.2 × 10⁻² | 2.1 × 10⁻² | B | 0.3 | C |
| Comp. Ex. 4 | 1.5 × 10⁻³ | 1.5 × 10⁻¹ | 1.5 × 10⁻¹ | 2.4 × 10⁻² | 2.3 × 10⁻² | B | 2.7 | D |
| Comp. Ex. 5 | 1.4 × 10⁻³ | 1.2 × 10⁻¹ | 1.2 × 10⁻¹ | 2.4 × 10⁻² | 2.3 × 10⁻² | B | 0.8 | C |

From Table 2, it was confirmed that the stacked body for a display device in Examples 1 to 9 had excellent bending resistance. Meanwhile, in Comparative Example 1 wherein ΔE1 was less than-1.0×10⁻² μm/g, and in Comparative Examples 2 to 5 wherein ΔE1 was more than 1.0×10⁻¹ μm/g, a peeling occurred in the bent portion in the dynamic bending test and the visibility of the bent portion, after the bending test, degraded.

That is, the present disclosure is able to provide the following inventions.

[1]

A stacked body for a display device comprising a first inorganic compound layer, a second inorganic compound layer, a hard coating layer, and a substrate layer, in this order, wherein
a difference ΔE1(E2−E1) between an erosion rate E1 at a first interface that is an interface between the first inorganic compound layer and the second inorganic compound layer; and an erosion rate E2 at a second interface that is an interface between the second inorganic compound layer and the hard coating layer, is in a range of −1.0×10⁻² μm/g or more and 1.0×10⁻¹ μm/g or less.
   [2]

The stacked body for a display device according to [1], wherein a difference ΔE2(E3-E1) between an erosion rate E3 of the first inorganic compound layer; and the erosion rate E1 at the first interface, is in a range of 0.0 μm/g or more and less than 2.0×10⁻² μm/g.

[3]

The stacked body for a display device according to [1] or [2], wherein a refractive index of the first inorganic compound layer is less than a refractive index of the second inorganic compound layer.

[4]

The stacked body for a display device according to any one of [1] to [3], wherein a fluorine-containing layer is included on a surface of the first inorganic compound layer that is opposite side to the second inorganic compound layer.

[5]

The stacked body for a display device according to any one of [1] to [4], wherein a first inorganic compound included in the first inorganic compound layer is silicon oxide.

[6]

The stacked body for a display device according to any one of [1] to [5], wherein a thickness of the first inorganic compound layer is 30 nm or more and 200 nm or less.

[7]

The stacked body for a display device according to any one of [1] to [6], wherein a total thickness of the first inorganic compound layer and the second inorganic compound layer is 500 nm or less.

[8]

The stacked body for a display device according to any one of [1] to [7], wherein a second inorganic compound included in the second inorganic compound layer is any one of aluminum oxide, zirconium oxide, and niobium oxide.

[9]

The stacked body for a display device according to any one of [1] to [8], wherein a thickness of the second inorganic compound layer is 20 nm or more and 300 nm or less.

[10]

The stacked body for a display device according to any one of [1] to [9], wherein a luminous reflectance of regular reflection light, when light is entered to a first inorganic compound layer side surface of the stacked body for a display device with incident angle of 5°, is 2.0% or less.

[11]

The stacked body for a display device according to any one of [1] to [10], wherein an adhesive layer for adhesion is included on a surface of the substrate layer that is opposite side to a hard coating layer side surface.

[12]

A display device comprising:
a display panel, and
the stacked body for a display device according to any one of [1] to placed on an observer side of the display panel.

### REFERENCE SIGNS LIST

1: stacked body for a display device
2: first inorganic compound layer
3: second inorganic compound layer
4: hard coating layer
5: substrate layer
6: fluorine-containing layer
7: adhesive layer for adhesion
20: flexible display device
21: display panel

1. A stacked body for a display device comprising a first inorganic compound layer, a second inorganic compound layer, a hard coating layer, and a substrate layer, in this order, wherein
a difference ΔE1(E2−E1) between an erosion rate E1 at a first interface that is an interface between the first inorganic compound layer and the second inorganic compound layer; and an erosion rate E2 at a second interface that is an interface between the second inorganic compound layer and the hard coating layer, is in a range of −1.0×10⁻² μm/g or more and 1.0×10⁻¹ μm/g or less.

2. The stacked body for a display device according to claim 1, wherein a difference ΔE2(E3−E1) between an erosion rate E3 of the first inorganic compound layer; and the erosion rate E1 at the first interface, is in a range of 0.0 μm/g or more and less than 2.0×10⁻² μm/g.

3. The stacked body for a display device according to claim 1, wherein a refractive index of the first inorganic compound layer is less than a refractive index of the second inorganic compound layer.

4. The stacked body for a display device according to claim 1, wherein a fluorine-containing layer is included on a surface of the first inorganic compound layer that is opposite side to the second inorganic compound layer.

5. The stacked body for a display device according to claim 1, wherein a first inorganic compound included in the first inorganic compound layer is silicon oxide.

6. The stacked body for a display device according to claim 1, wherein a thickness of the first inorganic compound layer is 30 nm or more and 200 nm or less.

7. The stacked body for a display device according to claim 1, wherein a total thickness of the first inorganic compound layer and the second inorganic compound layer is 500 nm or less.

8. The stacked body for a display device according to claim 1, wherein a second inorganic compound included in the second inorganic compound layer is any one of aluminum oxide, zirconium oxide, and niobium oxide.

9. The stacked body for a display device according to claim 1, wherein a thickness of the second inorganic compound layer is 20 nm or more and 300 nm or less.

10. The stacked body for a display device according to claim 1, wherein a luminous reflectance of regular reflection light, when light is entered to a first inorganic compound layer side surface of the stacked body for a display device with incident angle of 5°, is 2.0% or less.

11. The stacked body for a display device according to claim 1, wherein an adhesive layer for adhesion is included on a surface of the substrate layer that is opposite side to a hard coating layer side surface.

12. A display device comprising:
a display panel, and
the stacked body for a display device according to claim 1 placed on an observer side of the display panel.
